(19) United States
(12) Patent Application Publication
(10) Pub. No.: US 2022/0268242 A1
(43) Pub. Date: Aug. 25, 2022

(54) Failure Diagnostic Apparatus for Fuel Vapor Treatment Device

(71) Applicant: AISAN KOGYO KABUSHIKI KAISHA, Obu-shi (JP)

(72) Inventor: Hiroyuki TAKAHASHI, Nagoya-shi (JP)

(73) Assignee: AISAN KOGYO KABUSHIKI KAISHA, Obu-shi (JP)

(21) Appl. No.: 17/675,167

(22) Filed: Feb. 18, 2022

(30) Foreign Application Priority Data
Feb. 25, 2021 (JP) 2021-028349

(51) Int. Cl. F02M 25/08

(52) U.S. Cl. CPC F02M 25/0818; F02M 25/0836

(57) ABSTRACT

A failure diagnostic apparatus for a fuel vapor treatment device includes a case, a fuel inflow means, and a fuel discharge means. The case is disposed inside the fuel tank. A canister is accommodated in the case. The case shields the canister from the fuel in the fuel tank and provides a gap between an inner surface of the case and an outer surface of the canister. The fuel inflow means is activated when the fuel tank is refueled, and allows the fuel in the fuel tank to flow into the case. The fuel discharge means is activated during failure diagnosis by the failure diagnostic means, and drains the fuel in the case into the fuel tank.

### CROSS-REFERENCE TO RELATED APPLICATIONS

This application claims priority to Japanese patent application serial number 2021-028349 filed Feb. 25, 2021, which is hereby incorporated herein by reference in its entirety for all purposes.

### STATEMENT REGARDING FEDERALLY SPONSORED RESEARCH OR DEVELOPMENT

Not applicable.

### BACKGROUND

This disclosure relates generally to failure diagnostic apparatuses and methods for fuel vapor treatment devices.

A conventional fuel vapor treatment device may capture fuel vapor generated in a fuel tank by adsorbing it within a canister, and then either burn the fuel vapor in an engine or circulate the fuel vapor back into the fuel tank. For some fuel vapor treatment devices, a configuration has been considered in which the canister is installed inside the fuel tank to prevent the fuel vapor from leaking into the atmosphere in the event the fuel vapor leaks from the canister. Such configuration may be referred to as a configuration in which the canister is installed in the fuel tank.

A failure diagnostic apparatus may diagnose failures related to the airtightness of the fuel vapor treatment device. In a fuel vapor treatment device including the canister installed in the fuel tank, if fuel adheres to the outside of the canister during failure diagnosis, the fuel may block any leakage holes. As a result, it may not be possible to accurately diagnose failures related to the airtightness of the canister. Therefore, for a fuel vapor treatment device including a canister installed in the fuel tank, the canister may be disposed in a case in the fuel tank to prevent fuel from adhering to the outside of the canister (e.g., see Japanese Laid-Open Patent Publication No. 2005-54704).

In order to improve the adsorption performance of a canister and the desorption performance of the adsorbed fuel vapor, there is a fuel vapor treatment device that cools and heats the canister by flowing fuel around the canister (e.g., see Japanese Laid-Open Patent Publication No. S64-347).

### SUMMARY

According to a first embodiment disclosed herein, a failure diagnostic apparatus for a fuel vapor treatment device includes a canister, a vapor passage, a vapor valve, a purge passage, a purge valve, a case, and an Electronic Control Unit (ECU). The canister adsorbs and captures fuel vapor generated in a fuel tank. The vapor passage introduces the fuel vapor generated in the fuel tank into the canister. The vapor valve opens and closes the vapor passage. The purge passage supplies the fuel vapor captured in the canister to an engine or circulates the fuel vapor back into the fuel tank. The purge valve opens and closes the purge passage. The case is disposed inside the fuel tank and accommodates the canister. The case shields the canister from the fuel in the fuel tank. A gap is provided between the outer surface of the canister and the inner surface of the case. Fuel may flow through the gap. The failure diagnostic apparatus for the fuel vapor treatment device also includes a failure diagnostic means, a fuel inflow means, and a fuel discharge means, which are controlled and operated by the ECU. The failure diagnostic means performs a failure diagnosis of the airtightness of the canister by monitoring pressure changes in the canister after the canister has been subjected to a positive pressure greater than atmospheric pressure or a negative pressure less than atmospheric pressure. The fuel inflow means is activated when the fuel tank is refueled, and allows the fuel in the fuel tank to flow into the case. The fuel draining means is activated at the time of failure diagnosis by the failure diagnosis means, and drains the fuel in the case into the fuel tank.

According to the first embodiment, fuel flows into the case by the fuel inflow means at the time of refueling. Consequently, the canister, which generates heat by adsorbing fuel vapor during refueling, may be cooled by the fuel. As a result, the degradation of adsorption performance of the canister due to the heat generation may be suppressed. The fuel in the case is discharged into the fuel tank by the fuel discharge means at the time of diagnosing a canister failure. As a result, an air layer is formed around the canister, and the failure diagnosis of the canister may be performed accurately without being affected by fuel that may otherwise adhere to the outside of the canister.

A second embodiment disclosed herein is the failure diagnostic apparatus for the fuel vapor treatment device according to the first embodiment further including a jet pump and a switching valve. The fuel inflow means and the fuel discharge means are integral. The jet pump generates a negative pressure due to the fuel pumped by the fuel pump, and that negative pressure causes the fuel to flow. The switching valve switches the fuel flowed by the jet pump to be the fuel flowing from the fuel tank into the case or the fuel discharged from the case into the fuel tank.

According to the second embodiment, the fuel flow by the jet pump is switched by the switching valve. This allows the fuel in the fuel tank to flow into the case or the fuel in the case to be discharged into the fuel tank. Therefore, the functions of the fuel inflow means and the fuel discharge means may be achieved together. Such arrangement may simplify the configuration of the system.

A third embodiment disclosed herein is the failure diagnostic apparatus for the fuel vapor treatment device according to the first or second embodiment, wherein the case is provided with an open end. The open end is located higher than the fuel inlet that receives the fuel flowing in by the fuel inlet means. The open end is open to the space inside the fuel tank.

According to the third embodiment, when the gap between the canister and the case becomes full of fuel, the fuel overflows from the open end of the case. Therefore, fuel may flow in the gap between the canister and the case, and the canister may be cooled efficiently.

A fourth embodiment disclosed herein is the failure diagnostic apparatus for the fuel vapor treatment device according to the third embodiment, wherein the open end of the case is located lower than the opening on the side of the fuel tank of the vapor passage.

According to the fourth embodiment, since the position is lower than the opening on the side of the fuel tank of the vapor passage, it is possible to prevent the fuel from flowing into the vapor passage when the fuel overflows from the case.

A fifth embodiment disclosed herein is the failure diagnostic apparatus for fuel vapor treatment device according to any one of the first to fourth embodiments, wherein a part of the gap in the case is provided with a liquid level sensor chamber having a liquid level sensor that detects the liquid level of the fuel in the gap. The gap in the case and the liquid level sensor chamber may be in fluid communication with each other via a communication hole, and the communication hole may be provided with a check valve that permits the flow of fuel from the liquid level sensor chamber to the gap in the case, but prevents the flow of fuel in the opposite direction.

According to the fifth embodiment, the check valve prevents the fuel that flows into the case by the fuel inflow means during fuel refueling from flowing into the liquid level sensor chamber. Consequently, it is possible to prevent an error in the detection of the liquid level by the liquid level sensor in the liquid level sensor chamber. Also, when the fuel in the gap in the case is discharged by the fuel discharge means and an air layer is formed around the canister, the check valve is opened and the fuel in the liquid level sensor chamber is discharged together with the fuel in the case. As a result, the liquid level sensor may detect that the fuel in the gap in the case has been drained.

A sixth embodiment disclosed herein is the failure diagnostic apparatus for the fuel vapor treatment device according to any one of the first to fifth embodiments, wherein a fuel suction port on the side of the fuel tank of the fuel inflow means may be provided at the bottom of the fuel tank at a position lower than the case.

According to the sixth embodiment, since the fuel flowing into the case is taken in from the bottom of the fuel tank, relatively low temperature fuel may flow into the case, even if the fuel is from inside the fuel tank. Accordingly, the canister may be cooled more efficiently.

A seventh embodiment disclosed herein is the failure diagnostic apparatus for the fuel vapor treatment device according to any one of the first to sixth embodiments, wherein the fuel suction port on the side of the fuel tank of the fuel inflow means may be provided on an extension of the fuel inflow end on the side of the fuel tank of the filler pipe that supplies fuel into the fuel tank.

According to the seventh embodiment, since the fuel flowing into the case is mainly the fuel flowing into the fuel tank from the filler pipe, relatively cold fuel pumped from an underground tank may flow into the case. Accordingly, the canister may further be cooled more efficiently.

### BRIEF DESCRIPTION OF THE DRAWINGS

For a detailed description of various exemplary embodiments, reference will now be made to the accompanying drawings in which:

FIG. 1 is a schematic view of an embodiment of a system in accordance with the principles described herein.

FIG. 2 is a block diagram of a control circuit of the system of FIG. 1.

FIG. 3 is a flowchart illustrating an embodiment of a control routine implemented by the control circuit of FIG. 2 during refueling.

FIG. 4 is an enlarged, partial schematic view of the system of FIG. 1 during refueling, and in particular, immediately after the start of refueling.

FIG. 5 is an enlarged, partial schematic view of the system of FIG. 1 during refueling, and in particular, after a predetermined time has elapsed since the start of refueling.

FIG. 6 is a flowchart illustrating an embodiment of a fault diagnosis routine implemented by the control circuit of FIG. 2.

FIG. 7 is an enlarged, partial schematic view of the system of FIG. 1 during fault diagnosis, and in particular, before the start of fault diagnosis.

FIG. 8 is an enlarged, partial schematic view of the system of FIG. 1 during fault diagnosis, and in particular, immediately before the start of fault diagnosis.

FIG. 9 is a schematic view of an embodiment of a slide valve that may be used in another embodiment, showing the slide valve in a first slide position.

FIG. 10 is a schematic view of the slide valve of FIG. 9 in a second slide position.

### DETAILED DESCRIPTION

When a canister is shielded from fuel inside a case within the fuel tank, the heat dissipation of the canister may be poor, which may negatively impact fuel adsorption by the canister. On the other hand, if fuel flows into the case to cool the canister, it may not be possible to diagnose failures related to the airtightness of the canister (i.e., it may not be possible to assess whether the canister is sufficiently sealed to prevent leakage of fuel vapor).

An objective of embodiments of the present disclosure is that, in a failure diagnostic apparatus for a fuel vapor treatment device including a canister accommodated in a case inside a fuel tank, fuel is flowed into the case when refueling the fuel tank and fuel is discharged from the case when performing fault diagnosis concerning the airtightness of the canister. Accordingly, embodiments described in the present disclosure enable both (i) failure diagnosis related to the airtightness of the canister and (ii) suppression of a decrease in the adsorption capacity of the canister during refueling.

In order to achieve the above objectives, embodiments of the failure diagnostic apparatus for the fuel vapor treatment device disclosed herein may take at least the following configurations.

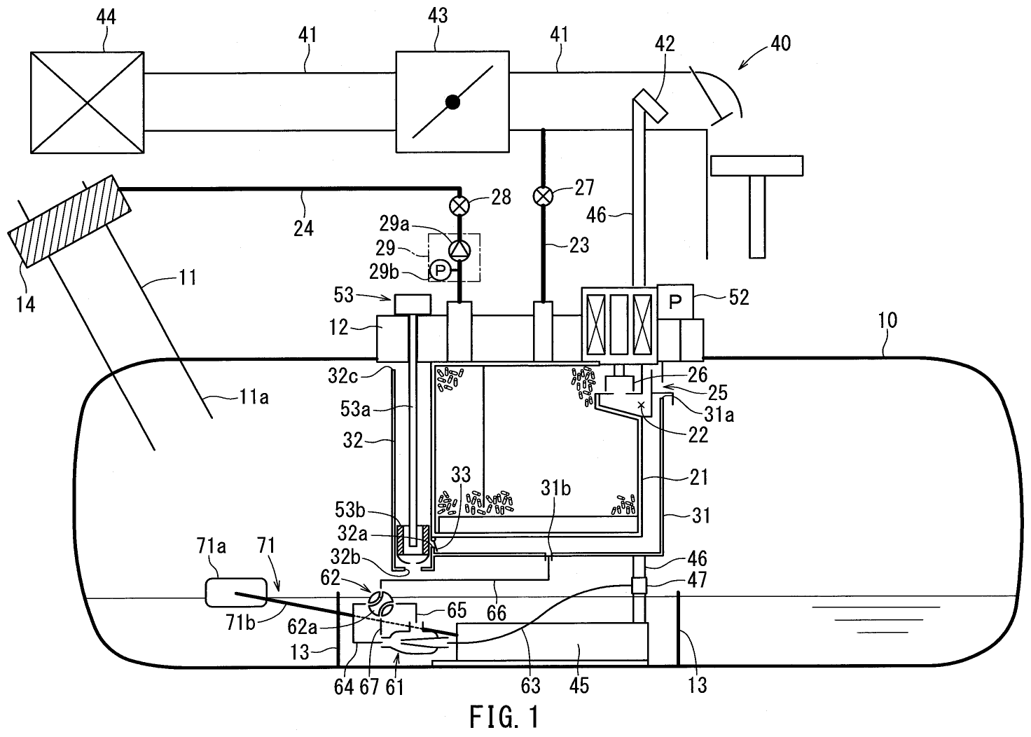

FIG. 1 is an embodiment of a system in accordance with the principles described herein and for achieving the above objectives. The embodiment shown in FIG. 1 is an example of an application to a gasoline engine 40 of a vehicle. Of course, embodiments disclosed herein may also be applied to engines other than vehicle engines.

The engine 40 includes an intake pipe 41 that intakes and receives air cleaned by an air cleaner 44. A throttle valve 43 is disposed along the intake pipe 41 downstream of the air cleaner 44 relative to the intake air flow direction (to the right in FIG. 1). The throttle valve 43 controls of the amount of intake air. In addition, a fuel injection valve 42 is disposed along the intake pipe 41 downstream of the throttle valve 43 relative to the intake air flow direction. The fuel injection valve 42 supplies fuel to the cylinder of the engine 40.

The fuel to be supplied to the engine 40 is stored in a fuel tank 10. A fuel pump 45 is provided at the bottom of the fuel tank 10 for pumping fuel to the fuel injection valve 42. In particular, the fuel pump 45 is disposed in a sub-tank 13 within the fuel tank 10. The sub-tank 13 is provided so that even if the vehicle is inclined with little residual fuel left in the fuel tank 10, fuel can still be sucked in at the fuel suction port of the fuel pump 45 (not shown). The sub-tank 13 is a container fixed to the bottom of the fuel tank 10. The fuel pump 45 supplies the fuel in the sub-tank 13 to the fuel injection valve 42 via a fuel pipe 46. A pressure regulator 47 is disposed in the middle of the fuel pipe 46, and adjusts the pressure of the fuel supplied to the fuel injection valve 42 so as to be at a constant pressure. A canister 21 is installed inside the fuel tank 10.

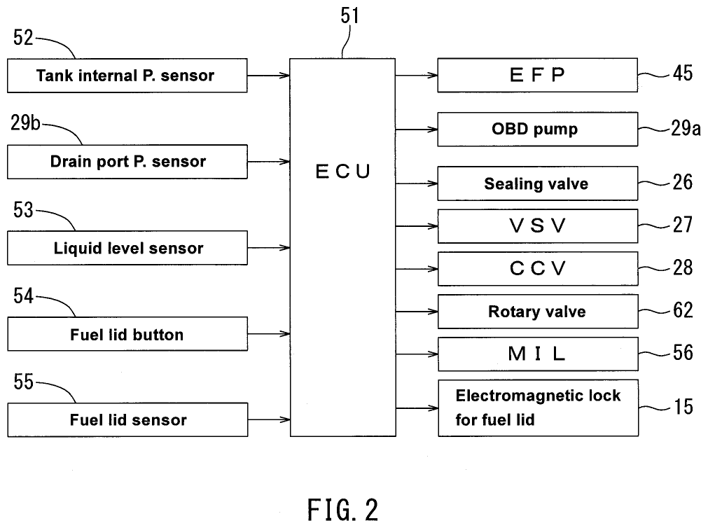

A filler pipe 11 is connected to the fuel tank 10 for refueling the fuel tank 10. Refueling the fuel tank 10 is performed by inserting the tip of a fueling gun (not shown) into the upper end opening of the filler pipe 11 (not shown). A fuel cap (not shown) is provided on the upper end opening of the filler pipe 11. The fuel cap prevents the fuel in the fuel tank 10 from leaking out by flowing backward through the filler pipe 11. The outside of the fuel cap may be covered by a fuel lid (not shown) to prevent theft. The fuel lid is locked in the closed state by an electromagnetic lock (see FIG. 2). To open the fuel lid, the electromagnetic lock is electrically unlocked. Then, the fuel lid is opened by the biasing force of a spring (not shown). When the fuel lid is closed manually against the biasing force of the spring, the electromagnetic lock for the fuel lid 15 is locked and the closed state is maintained.

An air filter 14 is provided along the filler pipe 11 at or proximal the opening at the upper end of the filler pipe 11. The air filter 14 is connected to the end of an atmospheric passage 24 that supplies atmospheric air to the canister 21. The air filter 14 removes dust, etc. from the atmospheric air supplied to the canister 21.

A sender gauge 71 is provided on the outer wall of the fuel pump 45. The sender gauge 71 includes a float arm 71b and a float 71a. The float arm 71b is supported by the outer wall of the fuel pump 45 and allowed to swing or pivot freely relative thereto. The float 71a is mounted to the distal end of the float arm 71b and is made of a material that floats on fuel. The float 71a moves up and down according to the liquid level of fuel in the fuel tank 10. The float arm 71b pivots relative to the fuel pump 45 in response to the vertical movement of the float 71a. The amount of fuel remaining in the fuel tank 10 is measured and detected by the pivot angle of the float arm 71b.

A configuration of the fuel vapor treatment device will now be described. An opening is provided in the upper surface of the fuel tank 10 for inserting the fuel pump 45 and the canister 21 into the fuel tank 10. The opening is covered with a set plate 12. Thus, the opening is closed by the set plate 12. The canister 21 and a case 31 within which the canister 21 is disposed are fixably coupled to the lower surface of the set plate 12. The sides and bottom of the canister 21 are surrounded by the case 31 when the canister 21 is positioned in the fuel tank 10. Accordingly, the case 31 can block and shield the canister 21 from the fuel inside the fuel tank 10. A gap is provided between the outer surface of the canister 21 and the inner surface of the case 31 to allow fuel to be selectively and controllably flowed therebetween. The gap is sufficiently large to allow cooling of the canister 21 by the fuel flowing through the gap. The upper part of the case 31 is open to and in fluid communication with the surrounding space inside the fuel tank 10. The height of an open upper end 31a of the case 31 is lower than the entrance of a labyrinthine structure 25 that will be described in more detail below.

The case 31 includes a float chamber 32 that defines a liquid level sensor chamber. The float chamber 32 is in fluid communication with the inside of the case 31 via a communication hole 32a. The communication hole 32a is provided with a check valve 33. The check valve 33 allows fuel to flow from the float chamber 32 to the inside of the case 31, but prevents fuel from flowing from the inside of the case 31 to the float chamber 32. The bottom of the float chamber 32 is provided with a communication hole 32b that allows fuel to flow freely between the float chamber 32 and the inside of the fuel tank 10 disposed about the case 31. The upper end of the float chamber 32 is in communication with the fuel tank 10 via a communication hole 32c provided at an upper end of the case 31.

A liquid level sensor 53 is provided in the float chamber 32. The liquid level sensor 53 includes a rod 53a and a float 53b. The rod 53a extends vertically through the set plate 12 and is vertically supported. The float 53b is slidably mounted to the rod 53a such that the float 53b is free to move vertically relative to the rod 53a. The float 53b is made of a material that floats on fuel. The sliding position of the float 53b relative to the rod 53a is output as an electrical signal to a control circuit 51, which will be described in more detail below.

The canister 21 is in fluid communication with the fuel tank 10 via a vapor passage 22 such that the fuel vapor generated in the fuel tank 10 can be adsorbed by the activated carbon filling the canister 21. A sealing valve 26, which is driven by a step-motor, is disposed in the middle of the vapor passage 22. The sealing valve 26 may also be referred to as a vapor valve herein. The vapor passage 22 is opened and closed by the sealing valve 26. The labyrinthine structure 25 is provided at the opening of the vapor passage 22 to the inside of the fuel tank 10. The labyrinthine structure 25 allows fuel vapor to flow into the vapor passage 22, but prevents liquid fuel from flowing into the vapor passage 22.

A purge passage 23 and the atmospheric passage 24 are in fluid communication with the canister 21 through the set plate 12. The purge passage 23 is in fluid communication with the intake pipe 41 at a position downstream of the throttle valve 43. A purge valve 27, which may be a solenoid valve, is disposed in the middle of the purge passage 23. The purge passage 23 may be opened and closed by the purge valve 27. The atmospheric passage 24 is in fluid communication with the air filter 14 as described above. In the middle of the atmospheric passage 24, a canister sealing valve 28, which may be a solenoid valve, and a failure diagnostic module 29 are provided. The atmospheric passage 24 may be opened and closed by the canister sealing valve 28.

A configuration of the failure diagnostic apparatus for the fuel vapor treatment device now will be described. The failure diagnostic module 29 includes a failure diagnostic pump 29a, which is an electric pump, and a drain port pressure sensor 29b. The failure diagnostic pump 29a pumps air from the canister 21 through the atmospheric passage 24 to the air filter 14. The drain port pressure sensor 29b detects the pressure in the canister 21 via the atmospheric passage 24. A tank internal pressure sensor 52 is mounted to the set plate 12 and detects the pressure of the fuel vapor in the fuel tank 10.

A configuration of the fuel inflow means and the fuel discharge means will now be described. A jet pump 61, which functions as a negative pressure generating device, is provided in the sub-tank 13 adjacent to the fuel pump 45. Excess fuel discharged from the pressure regulator 47 is supplied to the jet pump 61 via a pipe 63. The jet pump 61 directs the fuel pumped from the pipe 63 to the pipe 64. As a result, a negative pressure is generated in the pipe 65. The pipe 64 is in fluid communication with the pipe 65 via a rotary valve 62, which corresponds to an embodiment of a switching valve. In the rotary valve 62, a pipe 66 and a pipe 67 are in fluid communication with the remaining two ports other than the two ports with which the pipe 64 and the pipe 65 are in fluid communication. The pipe 66 is in fluid communication with a fuel inlet 31b of the case 31. The fuel inlet 31b is provided at the lowest position of the case 31. The pipe 67 has an opening end at a position lower than the bottom of the case 31 and at a bottom part in the sub-tank 13. Further, the opening end of the pipe 67 may be disposed so that it is located on the extension of a fuel inlet end 11a of the filler pipe 11.

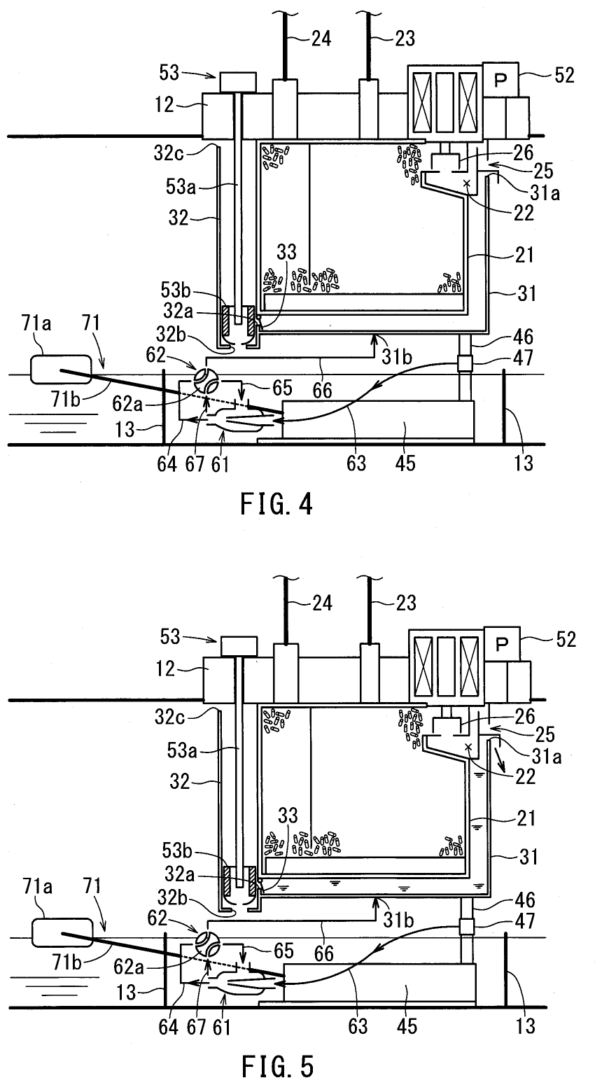

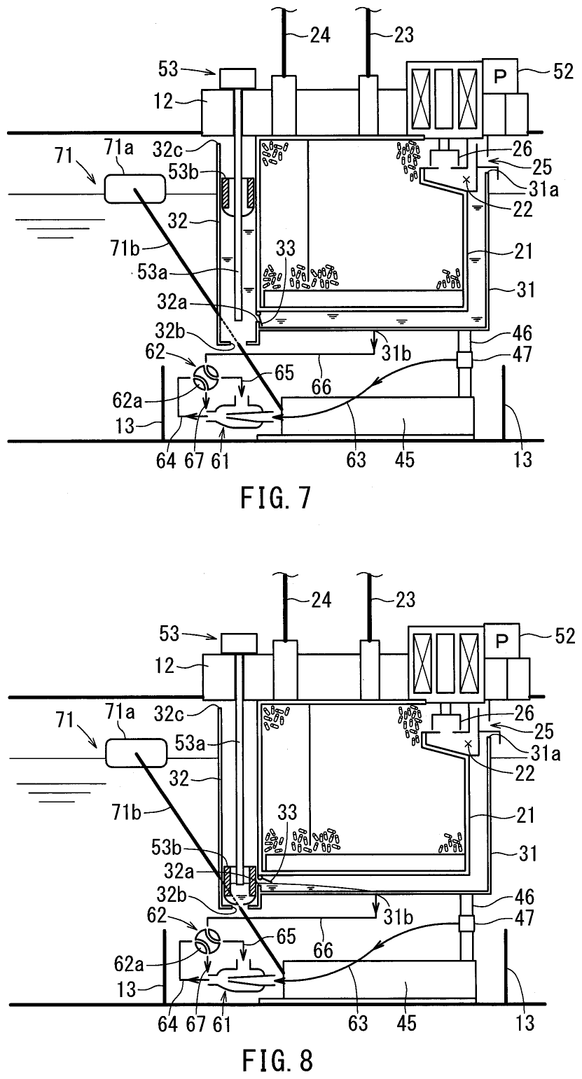

In the rotary valve 62, a rotor 62a is configured to rotate between two positions. In a first rotational position of the rotor 62a, the pipe 64 is in fluid communication with the pipe 66, and the pipe 65 is in fluid communication with the pipe 67, as shown in FIGS. 1, 4, and 5. In a second rotational position of the rotor 62a, the pipe 64 is in fluid communication with the pipe 67, and the pipe 65 is in fluid communication with the pipe 66, as shown in FIGS. 7 and 8. When the rotor 62a is in the first rotational position (e.g., see FIG. 4), which is also referred to herein as the refueling mode, the fuel in the sub-tank 13 is pumped and flows into the case 31 via the pipes 64, 66 in response to the negative pressure generated by the jet pump 61. When the rotor 62a is in the second rotational position (e.g., see FIG. 7), which is also referred to herein as the fault diagnosis mode, the fuel in the case 31 is discharged into the sub-tank 13 via the pipes 66, 65 in response to the negative pressure generated by the jet pump 61. Therefore, the jet pump 61, the rotary valve 62, and each of the pipes 63, 64, 65, 66, 67, collectively, define both the fuel inflow means and the fuel discharge means, which may be configured as a single unit.

An embodiment of the control circuit will now be described. The control of the fuel vapor treatment device with the canister 21 and the failure diagnosis concerning the airtightness of the canister 21 may be performed by the control circuit 51, together with the valve control of the fuel injection valve 42, etc. FIG. 2 shows only the parts related to the control of the fuel vapor treatment device and the failure diagnosis of the canister 21. The detection signals from the tank internal pressure sensor 52, the drain port pressure sensor 29b, the liquid level sensor 53, a fuel lid button 54, and a fuel lid sensor 55 are input to the input circuit(s) of the control circuit 51. The control circuit 51 outputs control signals to the fuel pump (EFP) 45, the pump for failure diagnostic pump (OBD pump) 29a, the sealing valve 26, the purge valve (VSV) 27, the canister sealing valve (CCV) 28, the rotary valve 62, a warning light (MIL) 56, and the solenoid lock 15 for the fuel lid.

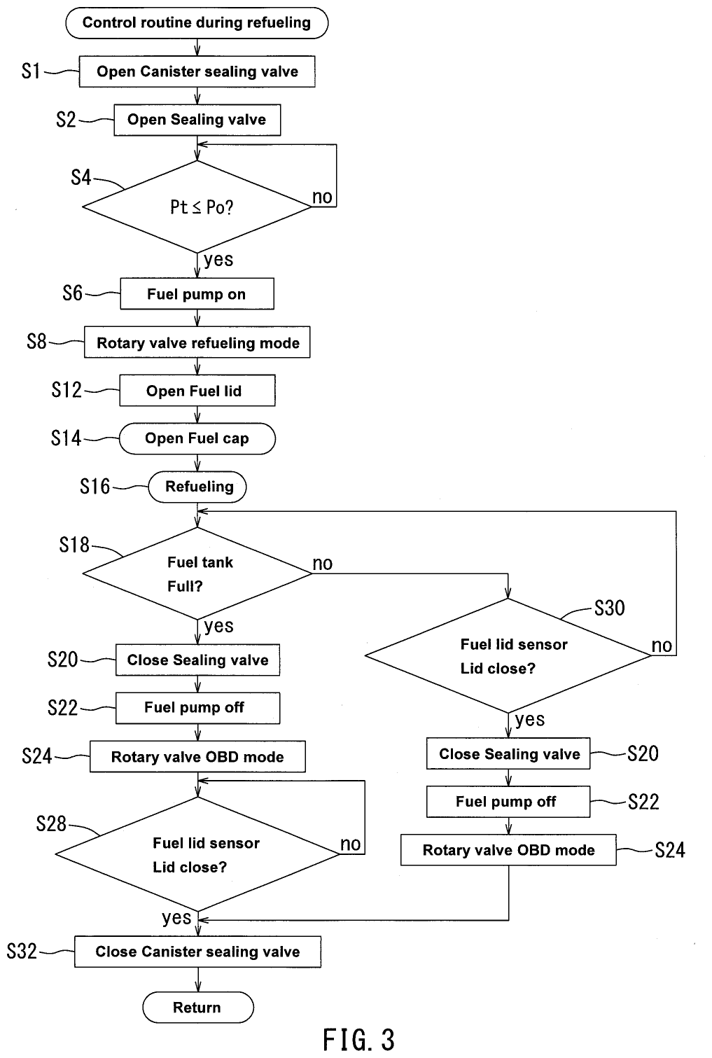

An operation of the fuel inflow means will now be described. FIG. 3 shows an embodiment of a control routine during refueling, which is part of the control program of the control circuit 51. The control routine during refueling is executed when the fuel lid button 54 is operated to refuel the fuel tank 10, and a corresponding operation signal is received. When the control routine during refueling is executed, the canister sealing valve 28 is opened at Step S1. At Step S2, the sealing valve 26 is opened. At Step S4, it is determined whether the tank internal pressure Pt of the fuel tank 10 detected by the tank internal pressure sensor 52 is less than or equal to atmospheric pressure Po. If the tank internal pressure Pt is greater than atmospheric pressure Po, it is determined to be No at Step S4. On the other hand, when the tank internal pressure Pt becomes less than or equal to the atmospheric pressure Po, it is determined to be Yes at Step S4, and the process proceeds to Step S6 and subsequent steps. Waiting for the tank internal pressure Pt to be less than or equal to atmospheric pressure Po prevents the fuel vapor in the fuel tank 10 from being released into the atmosphere through the filler pipe 11 when the fuel cap is opened after Step S6.

At Step S6, the fuel pump 45 begins operation. At Step S8, the rotary valve 62 is set to be in the refueling mode. At Step S12, the electromagnetic lock for the fuel lid 15 is energized to open the fuel lid. When the fuel lid is opened, the fuel cap is manually opened at Step S14. At Step S16, refueling can be performed using a refueling gun.

As shown in FIG. 4, the fuel pumped by the fuel pump 45 is supplied to the jet pump 61 via the pressure regulator 47 during refueling. As a result, the fuel in the sub-tank 13 flows into the case 31 (into the gap between the case 31 and the canister 21) via the rotary valve 62, which has been set to the refueling mode, in response to the negative pressure generated by the jet pump 61. Accordingly, the canister 21 is cooled by the fuel flowing into the case 31. As a result, the adsorption capacity of the fuel vapor of the canister 21 may be well maintained. That is, the canister 21 generates heat by adsorbing fuel vapor generated during refueling, and such heat reduces the fuel vapor adsorption capacity of the canister 21. However, since the canister 21 is cooled by the fuel flowing into the case 31, the generation of heat during refueling is suppressed and a decrease in adsorption capacity is suppressed.

As shown in FIG. 5, when fuel flows into the case 31, the check valve 33 closes due to the pressure of the fuel. Accordingly, the gap between the case 31 and the canister 21 is eventually filled with fuel. The fuel overflows from the open end 31a of the case 31, as shown by an arrow in FIG. 5. The fuel in the gap between the case 31 and the canister 21 flows from the fuel inlet 31b toward the open end 31a. The canister 21 is cooled by the continuously flowing fuel. Further, since the fuel flowing into the case 31 is the fuel directly supplied from the fuel inflow end 11a of the filler pipe 11, which is a relatively low-temperature fuel from an underground tank of a gas station, the canister 21 may be cooled more efficiently. Furthermore, the fuel flowing into the case 31 is the fuel at the bottom of the sub-tank 13. The fuel flowing into the case 31 may be a relatively low temperature fuel that is stored at a low position, even if the fuel is merely from the fuel tank 10. Accordingly, the canister 21 may be cooled efficiently.

At Step S18 of FIG. 3, it is determined whether the fuel tank 10 is full by the detection signal of the liquid level sensor 53 during refueling. When the fuel tank 10 is full, it is determined to be Yes at Step S18. At Step S20, the sealing valve 26 is closed. At Step S22, the fuel pump 45 is stopped. At Step S24, the rotary valve 62 is set in the failure diagnosis (OBD) mode.

When the sealing valve 26 is closed at Step S20 during refueling, the pressure in the fuel tank 10 rapidly increases. Then, the fuel injection by the refueling gun is automatically stopped due to the automatic stop function of the refueling gun. Upon the automatic stop of refueling, the refueling gun is pulled out of the filler pipe 11. When the fuel cap is closed and the fuel lid is manually closed, it is determined to be Yes at Step S28. At Step S32, the canister sealing valve 28 is closed to end the processing of the refueling control routine.

If the fuel tank 10 is not full, it is determined to be No at Step S18. At Step S30, it is determined whether the fuel lid has been manually closed. That is, it is determined whether the refueling has been arbitrarily stopped in a state before the tank is full, as determined at Step S30. If it is detected that the fuel lid has been closed, it is determined to be Yes at Step S30. Then, the processes of Steps S20 to S24, described above, are executed. Thereby, each part is put in a state ready for failure diagnosis. After Step S24, the canister sealing valve 28 is closed at Step S32 to end the processing of the refueling control routine.

A function of the fuel vapor treatment device will be described. During refueling, fuel vapor, which has passed through the vapor passage 22, is adsorbed and captured by the canister 21. When the engine 40 is operated, the intake pipe 41 is placed in a negative pressure state. When the purge valve 27 is opened, the previously adsorbed and trapped fuel vapor flows into the engine 40 and is burned. At this time, the sealing valve 26 is closed, but the canister sealing valve 28 is opened. Atmospheric air, which is taken from the air filter 14 via the canister sealing valve 28, is supplied to the canister 21. The fuel vapor, which had been adsorbed and captured by the canister 21, is desorbed and purged.

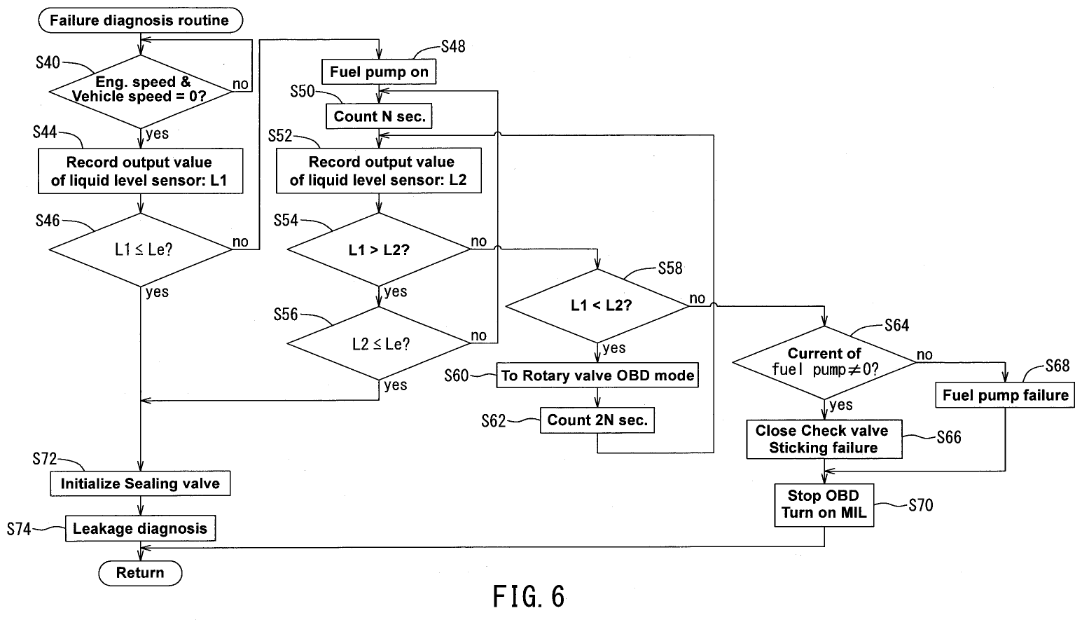

A function of the fuel discharging means will be described. FIG. 6 shows a failure diagnosis routine that is part of the control program of the control circuit 51. When the failure diagnosis routine is executed, it is determined whether the engine speed and the vehicle speed are zero at Step S40. That is, at Step S40, it is determined whether the vehicle is parked. When the vehicle is parked, it is determined to be Yes at Step S40. At Step S44, the output value of the liquid level sensor 53 is read and recorded as “L1.” At Step S46, the output value L1 of the liquid level sensor 53 is compared with a reference value Le. This may be done for determining whether the inside of the case 31 has an air layer. If there is fuel remaining in the case 31 and L1 is greater than Le, it is determined to be No at Step S46. Then, the fuel pump 45 is activated in Step S48.

When the refueling has been completed, the rotary valve 62 is in failure diagnostic mode. Therefore, when the fuel pump 45 is activated, the fuel in the case 31 is discharged into the fuel tank 10 by the negative pressure of the jet pump 61, which is shown in FIG. 7. When the fuel in the case 31 is discharged, the check valve 33 is opened and the fuel in the float chamber 32 is also discharged into the fuel tank 10, as shown in FIG. 8.

At Step S50, a certain number of seconds N are counted since the fuel pump 45 has started operating. At Step S52, the output value of the liquid level sensor 53 is read again and recorded as “L2.” At Step S54, it is determined whether L2 is smaller than L1. That is, it is determined whether the fuel in the case 31 is lower. If L2 becomes smaller than L1 and Step S54 is determined to be Yes, the output value L2 of the liquid level sensor 53 is compared again with the determination reference value Le at Step S56. Then, the processes from Step S50 to Step S54 are repeated until L2 becomes less than or equal to Le.

If L2 is not less than or equal to L1, it is determined to be No at Step S54. It is then determined whether L2 is larger than L1 at Step S58. That is, it is determined whether there is more fuel in the fuel tank 10. When the amount of fuel remaining in the fuel tank 10 is low and at the lowest level that may be measured by the level sensor 53, the fuel in the case 31 is drained into the fuel tank 10, such that the amount of the fuel in the fuel tank 10 increases. Then, it is determined to be Yes at Step S58. If it is determined to be Yes at Step S58, the rotary valve 62 is put into the fault diagnosis mode again at Step S60. At Step S62, a certain number of seconds 2N are counted. Then, the processes from Step S52 to Step S54 is repeated. As a result, if L2 becomes smaller than L1 and Step S54 is determined to be Yes, the process from Step S50 to Step S56 is repeated until L2 becomes less than or equal to Le at Step S56.

It is determined to be No at Step S58 if L2 is not greater than L1 at Step S58. Then, it is determined whether the operating current of the fuel pump 45 is zero at Step S64. That is, it is determined whether the fuel pump 45 is operating. It is determined to be Yes if the operating current of the fuel pump 45 is not zero. Then, it is determined that the check valve 33 is experiencing a sticking failure at Step S66. That is, when the rotary valve 62 is set to the failure diagnostic mode and the fuel pump 45 is operated, the fuel in the case 31 is discharged. Therefore, the check valve 33 is opened and the fuel in the float chamber 32 flows into the case 31. As a result, the fluid level detected by the liquid level sensor 53 should decrease. However, the fact that the liquid level does not decrease means that the check valve 33 is sticking and failing. At the next Step S70, the failure diagnosis is stopped and the warning light MTh is turned on to warn that there is an abnormality in the system.

At Step S64, it is determined to be No if the operating current of the fuel pump 45 is zero. Then, it is determined that the fuel pump 45 has a failure at Step S68. Even in this case, at the Step S70, the failure diagnosis is stopped and the warning light MIL is turned on to warn that there is an abnormality in the system.

A function of the failure diagnosis apparatus for the fuel vapor treatment device will be described. As a result of discharging the fuel from the case 31, and more specifically from the gap between the case 31 and the canister 21, the gap becomes filled with air and forms an air layer about the canister 21. Therefore, it is determined to be Yes at Step S46 or Step S56. Then, the sealing valve 26 is initialized and set to the closed position at Step S72. Leakage diagnosis of the canister 21, etc. are executed at Step S74. With the purge valve 27 and sealing valve 26 closed, the canister sealing valve 28 is opened and the failure diagnostic pump 19a of the failure diagnostic module 29 is operated for a certain period of time. As a result, the pressure inside the canister 21 becomes negative, which is lower than atmospheric pressure. In this state, the failure diagnostic pump 29a is deactivated and the canister sealing valve 28 is closed. Then, the drain port pressure sensor 29b detects and monitors any pressure change(s) in the canister 21. Depending on whether the change in pressure in the canister 21 after a predetermined time is within a predetermined range, it is diagnosed whether there is a hole in at least one of the canister 21, the purge passage 23 on the side of the canister 21 from the purge valve 27, and the atmospheric passage 24 on the side of the canister 21 from the canister sealing valve 28. The process at Step S74 corresponds to an embodiment of the failure diagnostic means.

Although the present disclosure has been described for a specific embodiment, it can be implemented in various other embodiments. For example, in the above embodiment, the treatment of the fuel vapor captured in the canister is flowed into the engine and burned, but a method of circulating the fuel in the fuel tank with an appropriate pump, one example of which is disclosed in Japanese Patent Registration No. 5318793, may be adopted. Japanese Patent Registration No. 5318793 is incorporated herein by reference.

In the above embodiment, when performing a failure diagnosis regarding the airtightness of the canister, the inside of the canister is set to a negative pressure lower than atmospheric pressure by an electric pump. However, the inside of the canister may be set to a positive pressure higher than atmospheric pressure by the electric pump. Further, an air pump other than the electric pump, for example, a jet pump, may be used to set the inside of the canister to a negative pressure lower than atmospheric pressure or a positive pressure higher than atmospheric pressure. Furthermore, the negative pressure generated by the engine may be introduced into the canister. Each of these methods is disclosed, for example, in Japanese Patent Registration No. 5318793.

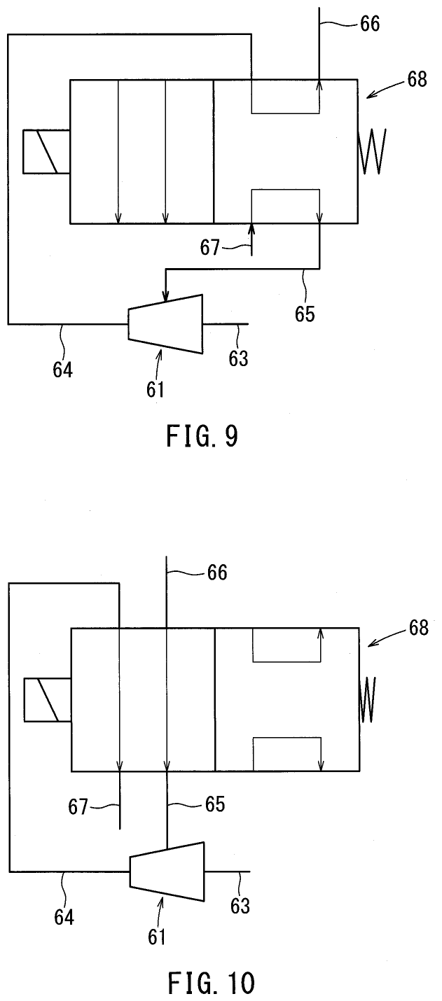

In the above embodiment, the fuel inflow means and the fuel discharge means are configured as a single unit, but they may be configured independent of each other. Also, in the above embodiment, the switching valve is configured by a rotary valve, but may instead be configured by a slide valve, for example. For example, a slide valve similar to the slide valve 68 shown in FIGS. 9 and 10 may be used. FIG. 9 shows a state in which the slide valve 68 is in the first slide position and the system is in the refueling mode. FIG. 10 shows a state in which the slide valve 68 is in the second slide position and the system is in the failure diagnostic mode. In FIGS. 9 and 10, the jet pump 61 and the pipes 63, 64, 65, 66, 67 may be substantially the same as those used in the embodiment shown in FIG. 1.

In the above embodiments, the fuel pumped from the fuel pump to the jet pump is supplied via the pressure regulator. However, in other embodiments the fuel may be supplied directly from the fuel pump to the jet pump. Further, in the above embodiments, the sub-tank is provided at the bottom of the fuel tank. However, in other embodiments the sub-tank may not be provided.

In the above embodiments, a float is used as a liquid level sensor. However, in other embodiments a detection element such as a thermistor may be used.

The various examples described above in detail with reference to the attached drawings are intended to be representative of the present disclosure and are thus non-limiting embodiments. The detailed description is intended to teach a person of skill in the art to make, use, and/or practice various aspects of the present teachings, and thus does not limit the scope of the disclosure in any manner. Furthermore, each of the additional features and teachings disclosed above may be applied and/or used separately or with other features and teachings in any combination thereof, to provide an improved failure diagnostic apparatus for a fuel vapor treatment device, and/or methods of making and using the same.

What is claimed is:

1. A failure diagnostic apparatus for a fuel vapor treatment device, the failure diagnostic apparatus comprising:
a canister configured to adsorb fuel vapor generated in a fuel tank;
a vapor passage configured to introduce the fuel vapor generated in the fuel tank into the canister;
a vapor valve configured to open and close the vapor passage;
a purge passage extending from the canister and configured to purge the fuel vapor captured in the canister;
a purge valve configured to open and close the purge passage;
a case that accommodates the canister and is disposed inside the fuel tank, wherein the canister is disposed in the case and the case is configured to shield the canister from fuel in the fuel tank, wherein a gap is disposed between an outer surface of the canister and an inner surface of the case, the gap being sized to allow fuel flow therein;
an electronic control unit (ECU) comprising at least one programmed processor and configured to perform a failure diagnosis regarding an airtightness of the canister based on a pressure change in the canister after the canister has been subjected to a positive pressure higher than atmospheric pressure or a negative pressure lower than atmospheric pressure;
a fuel inflow device configured to be activated when the fuel tank is refueled and allow the fuel in the fuel tank to flow into the gap; and
a fuel discharge device configured to be activated at the time of failure diagnosis and flow the fuel in the gap into the fuel tank.

2. The failure diagnostic apparatus for the fuel vapor treatment device of claim 1, wherein:
the fuel inflow device and the fuel discharge device are integrally configured and comprise:
a jet pump configured to generate a negative pressure that causes the fuel to flow; and
a switching valve configured to switch the flow of the fuel flowed by the jet pump between the flow from the fuel tank into the gap and the flow from the gap into the fuel tank.

3. The failure diagnostic apparatus for the fuel vapor treatment device of claim 1, wherein the case has an open end in fluid communication with a space inside the fuel tank outside the case, wherein the open end of the case is positioned above a fuel inlet configured to receive the fuel flowing into the gap by the fuel inflow device

4. The failure diagnostic apparatus for the fuel vapor treatment device of claim 3, wherein the open end of the case is positioned below an opening of the vapor passage in fluid communication with the fuel tank.

5. The failure diagnostic apparatus for the fuel vapor treatment device of claim 1, wherein:
a part of the gap is provided with a liquid level sensor chamber having a liquid level sensor configured to detect a liquid level of the fuel;
the liquid level sensor chamber and a remaining part of the gap in the case are in fluid communication with each other via a communication hole; and
the communication hole is provided with a check valve configured to permit the flow of fuel from the liquid level sensor chamber to the gap in the case and prevent the flow of fuel in the opposite direction.

6. The failure diagnostic apparatus for the fuel vapor treatment device of claim 1, wherein a fuel suction port on a side of the fuel tank of the fuel inflow device is provided at a bottom of the fuel tank at a position lower than the case.

7. The failure diagnostic apparatus for the fuel vapor treatment device of claim 1, wherein a fuel suction port on a side of the fuel tank of the fuel inflow device is provided on an extension of a fuel inflow end on a side of the fuel tank of a filler pipe, wherein the filler pipe is configured to supply fuel into the fuel tank.
